(19) United States
(12) Patent Application Publication
(10) Pub. No.: US 2005/0021806 A1
(43) Pub. Date: Jan. 27, 2005

(54) System and method for delivering data streams of multiple data types at diffferent priority levels

(76) Inventors: John William Richardson, Hamilton, NJ (US); Jens Cahnbley, Princeton Junction, NJ (US)

Correspondence Address: Joseph S Tripoli;Thomson Multimedia Licensing, P O Box 5312, Princeton, NJ, 08543-5312, US

(21) Appl. No.: 10/498,530

(22) PCT Filed: Dec. 12, 2002
(86) PCT No.: PCT/US02/39918

Related U.S. Application Data
(60) Provisional application No. 60/341,817, filed on Dec. 15, 2001.

(51) Int. Cl. G06F 15/16

(52) U.S. Cl. 709/231

(57) ABSTRACT

A Server (100) provides a data stream of data of a primary type and one or more secondary types and transmits the primary type data at a first designation and the data of the one or more secondary types at one or more other designations. A Router (600) routes data of the first designation through a Network (500) at a first priority and routes data of the one or more other designations through Network (500) at one or more priorities lower than the first priority such that, when congestion in Network (500) requires that data be discarded, Router (600) discards data of the one or more other designations before discarding data of the first designation. A Client (200) receives data of the first and of the one or more designations through Network (500) and combines the data to provide a representation of the data stream transmitted from Server (100).

### CROSS-REFERENCE TO RELATED APPLICATIONS

This application claims priority from U.S. Provisional Application No. 60/341,817 filed Dec. 15, 2001, which is hereby incorporated by reference into this application.

### FIELD OF THE INVENTION

The invention disclosed herein relates to a system and method for delivering data streams across a data communications network.

### BACKGROUND OF THE INVENTION

Data communication networks often respond to congestion by arbitrarily dropping data. The discarding of data without consideration as to the importance of the data can have severe negative consequences for certain types of data transmissions.

For example, video data generally comprises key frames and predictive frames, where the key frames, since they provide the basis for the predictive frames, are more important than predictive frames when the video data is processed for display to a user. Consequently, where video data streams are transmitted through a network suffering congestion, the arbitrary dropping of data can result in the loss of key frames which would severely degrade the quality of the video display generated from the received video data stream.

### SUMMARY OF THE INVENTION

The invention provides a method, system, and computer program product for delivering a data stream of multiple data types through a network so that, when congestion in the network causes data to be dropped, data of the stream of a data type that is of less importance is dropped before data of the stream of a data type that is of a greater importance. In accordance with the invention, a data stream to be delivered over a network includes data of a primary type and one or more secondary types. Primary type data is routed over the network at a first priority level and secondary type data is routed at one or more priority levels lower than the first priority level such that, when congestion in the network requires that data be discarded, secondary type data is discarded before primary type data. Then, primary and secondary type data routed over the network is combined to provide the data stream.

In an embodiment of the invention, the data stream is transmitted with data of the primary type being transmitted separately from data of the one or more secondary types. Then, data of the primary and the one or more secondary types routed over the network is combined to provide the data stream, the provided data stream being at least a representation of the transmitted data stream, i.e., the data stream if not data is discarded or a representation thereof if data is discarded.

In the preferred embodiment, the data stream is transmitted to a router, which routes primary type data at a first priority and secondary type data at one or more priority levels lower than the first priority level. According to an embodiment of the invention, where the data stream comprises a video stream, I frames of the video stream are transmitted in association with a first designation and P and B frames of the video stream are transmitted in association with one or more designations other than the first designation.

According to another embodiment of the invention where the data stream comprises a video stream, I frames of the video stream are transmitted, e.g., to the router in association with a first TCP/UDP port number, and P and B frames of the video stream are transmitted, e.g., to the router, in association with one or more TCP/UCP port numbers other than the first port number. Data, e.g., received at the router, associated with a first port number is routed through a network at a first priority level and data, e.g., received at the router, in association with one or more port numbers other than the first port number is routed through the network at one or more priority levels lower than the first priority level such that, when congestion in the network requires that data received, e.g., at the router, be discarded, data associated with the one or more port numbers other than the first port number is discarded before data associated with the first port number. Then, data routed over the network, e.g., from the router, associated with the first port number is combined with data received through the network from the router associated with the one or more port numbers other than the first port number to provide a representation of the transmitted video stream.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing an embodiment of the present invention and the environment in which it operates;

FIG. 2 is a block diagram showing another embodiment of the invention;

FIG. 3 is a block diagram showing another embodiment of the invention;

FIG. 4 is a flowchart showing an operative embodiment of the invention; and

FIG. 5 is a flowchart showing another operative embodiment of the invention.

### DETAILED DESCRIPTION

Preferred embodiments of a method, system, and article of manufacture containing software programs in accordance with the present invention are described with reference to the drawings.

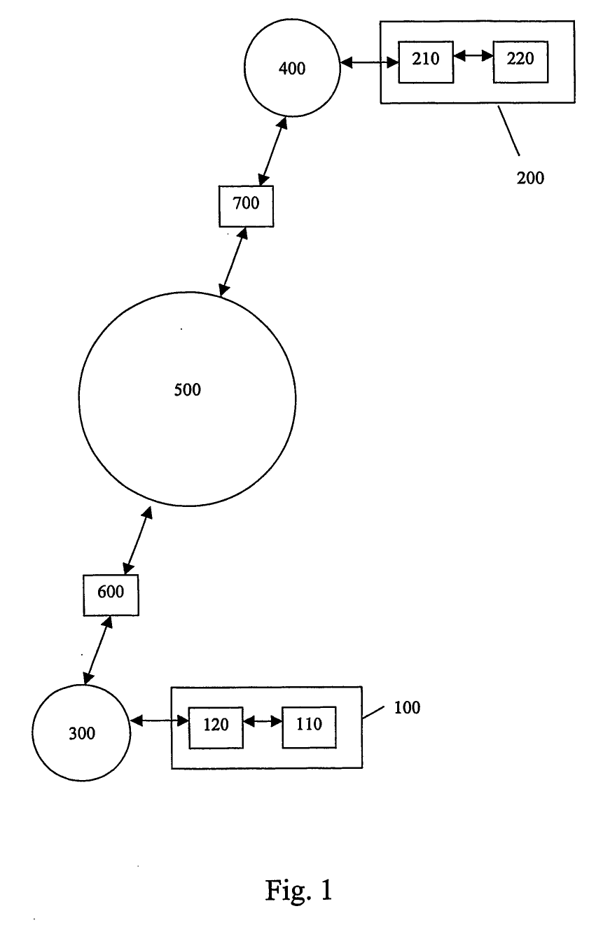

As shown in FIG. 1, a Server 100 is linked to a Client 200 through a First Network 300, a First Router 600, a Second Network 400, a Second Router 700, and a Third Network 500. Server 100 may encompass any computer system capable of (a) providing a data stream comprising data of a primary type and one or more secondary types where the data of the primary type serves as the basis for processing the data of the secondary types, and (b) transmitting the provided data stream such that the data of the primary type is transmitted in association with a first designation and the data of the secondary types is transmitted in association with one or more designations other than the first designation. An example of a data stream that may be provided by Server 100 is a video data stream (or simply “video stream”) comprising different types of video frames, such as key frames, forward predictive frames, and backward predictive frames (which may be referred to as I frames, P frames, and B frames, respectively) where the key frames serve as the basis for processing the forward and backward predictive frames. The designations referred to above may comprise, for example, port numbers used by an IP network's transport layer, e.g., TCP or UDP, such that data of a data stream of the primary type may be transmitted in association with a first port number and data of the data stream of the secondary types may be transmitted in association with one or more port numbers other than the first port number.

In an embodiment of the invention, Server 100 comprises a Data Stream (“DS”) Provider System 110 and a Data Stream Transmitter (“DST”) System 120. The DS Provider System 110 may comprise any computer system capable of providing data streams as described above. For example, where the data stream to be provided comprises a video stream, DS Provider System 110 may comprise any known computer system for providing a video stream. Moreover, DS Provider System 110 may provide the video stream in any number of ways, such as, for example, based on live video data or previously recorded video files. In an embodiment of the invention, DS Provider System 110 comprises computer code for performing the function of providing the data stream as described above.

The DST System 120 may comprise any computer system capable of (a) separating the different types of data of the data stream and (b) transmitting the data of the primary type in association with a first designation and transmitting the data of the one or more secondary types in association with one or more designations other than the first designation. For example, where the data stream to be transmitted is a video stream, DST System 120 may comprise a computer system capable of separating the I frames, P frames, and B frames of the video stream and transmitting the I frames in association with a first TCP/UDP port number and transmitting the P and B frames in association with one or more TCP/UDP port numbers other than the first port number. For instance, P and B frames may both be transmitted in association with a second port number or the P and B frames may be transmitted in association with second and third port numbers, respectively. In an embodiment of the invention, DST System 120 comprises computer code for performing the data stream separation and transmission as described above.

Client 200 receives and processes the data streams generated and transmitted by Server 100. As such, Client 200 may comprise any computer system capable of (a) receiving data related to a given data stream and associated with a fourth designation and data related to the given data stream and associated with one or more designations other than the fourth designation, and combining the received data related to the given data stream and associated with the fourth designation and the received data related to the given data stream and associated with the designations other than the fourth designation to provide a data stream representative of the given data stream, and (b) processing the representative data stream.

In an embodiment of the invention, Client 200 comprises a Data Stream Receiving (“DSR”) System 210 and a Data Stream (“DS”) Processing System 220. DSR System 210 may comprise any computer system capable of performing the receiving operation described above. For example, where the data to be received and processed is video data, DSR System 210 may comprise any computer system capable of receiving I frames related to a given video stream and associated with a fourth port number and P and B frames related to the given video stream and associated with one or more port numbers other than the fourth port number (e.g., the P and B frames may both be received in association with a fifth port number or the P and B frames may be received in association with a fifth and sixth port number, respectively), and combining the received I, P, and B frames related to the given video stream to provide a video stream representative of the given video stream (e.g., where the representative stream may have fewer frames than the originally transmitted stream due to data loss from congestion, but where the frames remaining in the representative stream have identical counterparts in the originally transmitted stream). In an embodiment of the invention, DSR System 210 comprises computer code for performing the receiving and combining operations described above.

DS Processing System 220 may comprise any computer system capable of processing a data stream as described above. For example, where the representative stream is a video stream, DS Processing System 220 may comprise any known computer system capable of processing a video stream for display to a user. In an embodiment of the invention, DS Processing System 220 comprises computer code for performing the processing described above.

The term “computer system” here is used broadly and encompasses computer hardware and computer software or computer software only. For example, DS Provider System 110 and DST 120 may each comprise computer code that resides on the same computer hardware of Server 100. Alternatively, DS Provider System 110 and DST 120 may each be implemented in distinct computer hardware.

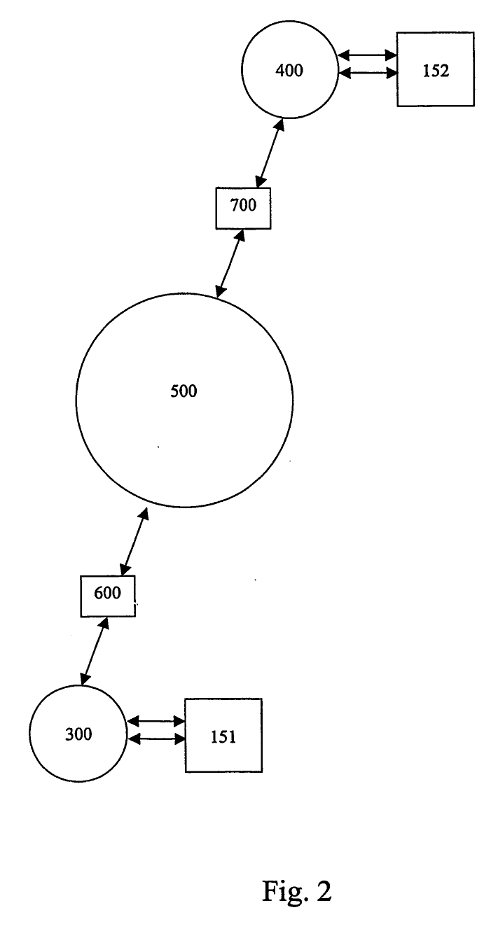

It should be noted that client and server functionality may be combined in a single system. In an embodiment of the invention, shown in FIG. 2, End User Systems 151 and 152 each may include the functionality of both Server 100 and Client 200, as described above, (e.g., such as for use in a video conferencing configuration) so that each may simultaneously send and receive data streams with other similar end user systems.

Returning to FIG. 1, Server 100 and Client 200 are in communication with First Network 300 and Second Network 400, respectively. Networks 300 and 400 communicate with a Third Network 500 through a First Router 600 and a Second Router 700, respectively. Networks 300, 400, and 500 each may comprise any data communication network capable of transferring data between computer systems, such as, for example, a LAN, a WAN, or the Internet. In an example configuration, Networks 300, 400, and 500 each may comprise networks typically used in a corporate intranet. For instance, Networks 300 and 400 may represent LANs at geographically separated corporate sites linked together by Network 500, which may represent a WAN.

Data may be routed over the any or all of Networks 300, 400 and 500 by any suitable hardware and/or software capable of performing the routing functions disclosed herein, and data may be discarded as disclosed herein by any hardware and/or software capable of performing the discarding functions disclosed herein. For example, such functions may be performed by Routers 600 and 700, which each may comprise any router capable of servicing data associated with a plurality of designations according to a plurality of priority levels such that, when congestion requires that data within the router be discarded, data associated with designations to be serviced according to a lower priority level is discarded before data associated with designations to be serviced according to a higher priority level. For example, Routers 600 and 700 each may comprise a Quality of Service (“QoS”) capable router capable of classifying received data associated with a plurality of port numbers into a plurality of levels of service such that, when congestion requires that data within the QoS router be discarded, data associated with port numbers classified into a lower level of service is discarded before data associated with port numbers classified into a higher level of service.

In an embodiment of the invention, Server 100, Client 200, and Routers 600 and 700, all are statically configured, e.g., through computer hardware or computer code, to transmit, receive, and service data, respectively, based on the same designations. For example, where the data steam at issue is a video stream, Server 100 may be configured to transmit the I frames of the video stream in association with a first destination port number (e.g., destination port number 5151) and transmit the P and B frames of video stream in association with one or more destination port numbers other than the first destination port number (e.g., P and B frames both in association with destination port number 5153 or P and B frames in association with destination port numbers 5153 and 5155, respectively). Also, continuing with the example, Client 200 may be configured to receive I frames of video streams on a fourth destination port number that is the same as the first destination port number (e.g., destination port number 5151) and the P and B frames for video streams on one or more destination port numbers other than the fourth destination port number that are the same as the one or more destination port numbers other than the first destination port number (e.g., P and B frames both in association with destination port number 5153 or P and B frames in association with destination port numbers 5153 and 5155, respectively).

Also, referring to the same example, Routers 600 and 700 may be configured to service data received in association with a first destination port number (e.g., destination port number 5151) according to a first priority level and one or more destination port numbers other than the first destination port number (e.g., destination port number 5153 or destination port numbers 5153 and 5155) according to a one or more priority levels lower than the first priority level such that, when congestion requires that data within the router be discarded, the data associated with the destination port numbers to be serviced according to a lower priority level is discarded before data associated with the destination port numbers to be serviced according to a higher priority level.

For instance, where Server 100 and Client 200 are configured to transmit and receive, respectively, I frames in association with a first destination port number (e.g., 5151) and P and B frames both in association with a single destination port number other than the first destination port number (e.g., destination port number 5153), then Routers 600 and 700 may be configured to service data received in association with the first destination port number according to a first priority level and service data received in association with the other port number according to a second priority level lower than the first priority level such that, when congestion requires that data within the router be discarded, the data associated with the other destination port number (e.g., P and B frames associated with destination port number 5153) is discarded before the data associated with the first destination number (e.g., I frames associated with destination port number 5151).

Alternatively, where Server 100 and Client 200 are configured to transmit and receive, respectively, I frames in association with a first destination port number (e.g., 5151), P frames in association with a second destination port number (e.g., 5153), and B frames in association with a third destination port number (e.g., 5155), then Routers 600 and 700 may be configured to service data received in association with the first, second, and third destination port numbers according to first, second, and third priority levels, respectively, such that, when congestion requires that data within the router be discarded, the data associated with the third destination port number (e.g., B frames at port number 5155) is discarded before data associated with the first and second destination port numbers (e.g., I frames at port number 5151 and P frames at port number 5153, respectively), and data associated with the second destination port number is discarded before data associated with the first destination port number.

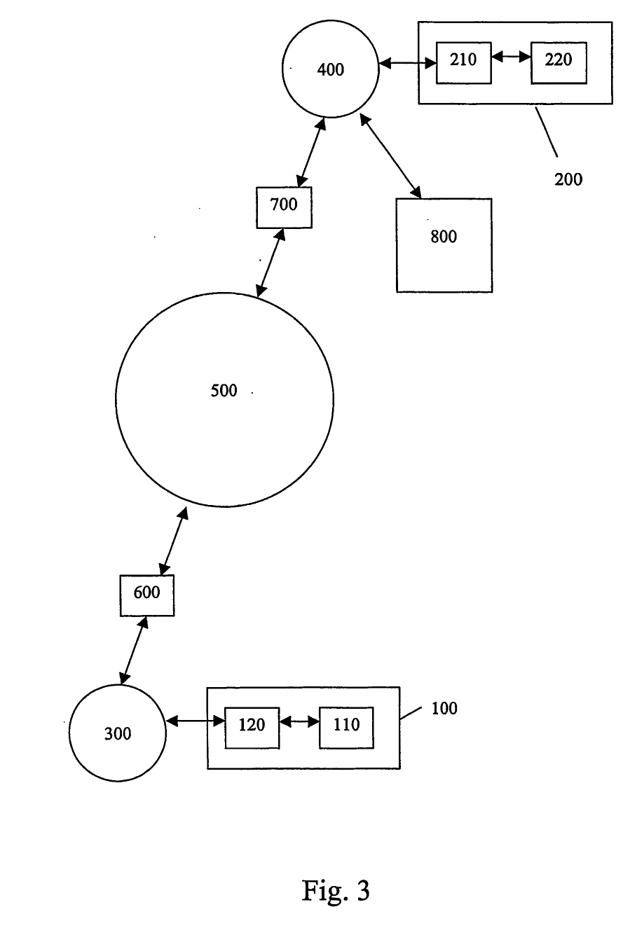

In another embodiment of the invention, Server 100, Client 200, and Routers 600 and 700 may transmit, receive, and service data, respectively, based on various user definable designations. In this embodiment, shown in FIG. 3, a Control System 800 communicates with Server 100, Client 200, and Routers 600 and 700 to instruct them to transmit, receive, and service data, respectively, based on the same designations as described above. For example, where video conferencing is to be performed, Control System 800 may retrieve from a policy server (not shown) a policy for video conferencing which may provide that, for example, in the video data, I frames be given high priority and be transmitted on port 5151, P frames be given medium priority and be transmitted on port 5153, and B frames be given a lower priority and be transmitted on port 5155. Control System 800 may then instruct Server 100 to transmit and Client 200 to receive the I, P, and B frames on ports 5151, 5153, and 5155, respectively and instruct Routers 600 and 700 to service data associated with ports 5151, 5153, and 5155 according to high, medium, and lower priorities, respectively.

Although Control System 800 is shown in FIG. 3 in communication with Server 100, Client 200, and Routers 600 and 700 through a link with Second Network 400, it should be noted that this is not necessary, and that Control System 800 may be linked at any network point, e.g., First Network 300 or Third Network 500, that enables it to communicate with Server 100, Client 200, and Routers 600 and 700.

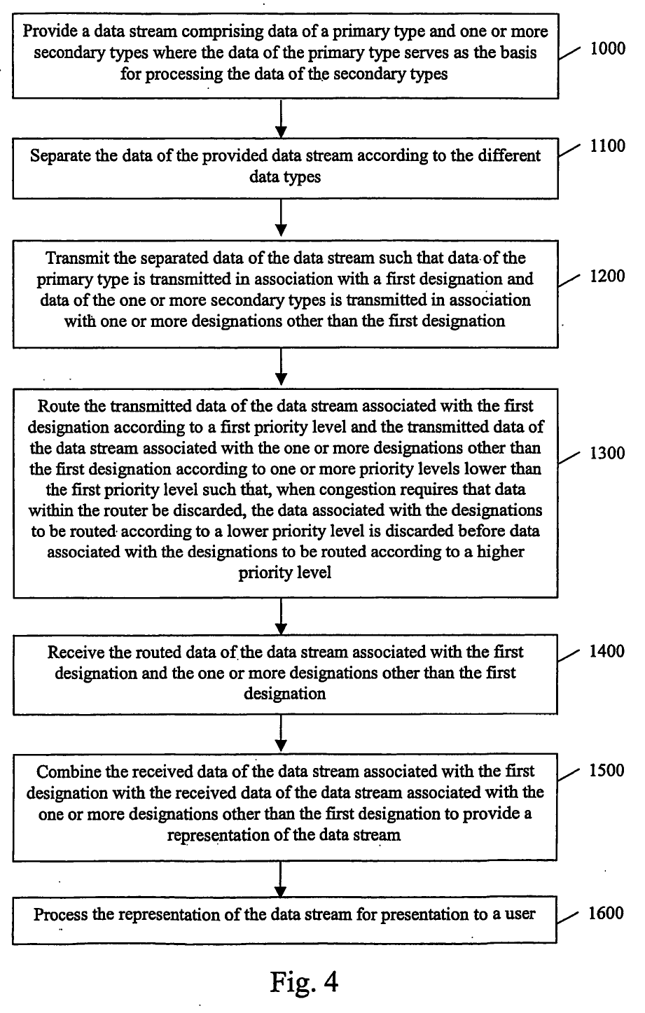

FIG. 4 is a flowchart showing one way in which the present invention may operate. First, as represented in block 1000, a data stream is provided comprising data of a primary type and one or more secondary types where the data of the primary type serves as the basis for processing the data of the secondary types. The data stream provided may comprise, for example, a video stream where the data of the primary type and one or more secondary types corresponds to I frames and P and B frames, respectively, of the video stream. Where the data stream comprises a video stream, then DS Provider System 110 of Server 100 may provide the video stream in a number of ways, such as, for example, by encoding live video, e.g., for video conferencing, or retrieving a prerecorded video file.

Next, the data of the provided data stream is separated according to the different data types, as represented in block 1100. For instance, where the provided data stream is a video stream, DST System 120 of Server 100 may perform the operations represented in block 1100 by, for example, separating the I, P, and B frames from the provided video stream.

The separated data of the data stream is then transmitted such that data of the primary type is transmitted in association with a first designation and data of the one or more secondary types is transmitted in association with one or more designations other than the first designation, as represented in block 1200. For instance, where the data stream is a video stream and it is desired to have I frames transmitted with high priority and P and B frames transmitted with the same priority lower than high priority, DST System 120 of Server 100 may perform the operations represented in block 1200 by, for example, transmitting I frames of the video stream in association with a first destination port number (e.g., 5151) and both P and B frames of the video stream in association with a destination port number other than the first destination port number (e.g., 5153). Alternatively, where the data stream is a video stream and it is desired to have I frames transmitted with high priority, P frames transmitted with medium priority, and B frames transmitted with lower priority, then DST System 120 of Server 100 may performed the operations represented in block 1200 by, for example, transmitting I, P, and B frames of the video stream in association with a first (e.g., 5151), a second (e.g., 5153), and a third (e.g., 5155) destination port number.

The transmitted data of the data stream is received at Router 600 which, as represented in block 1300, routes the transmitted data of the data stream associated with the first designation according to a first priority level and the transmitted data of the data stream associated with the one or more designations other than the first designation according to one or more priority levels lower than the first priority level such that, when congestion in Third Network 500 requires that data within the router be discarded, the data associated with the designations to be routed according to a lower priority level is discarded before data associated with the designations to be routed according to a higher priority level. For example, where the data stream is a video stream, Router 600 may be configured to route data associated with a first destination port number (e.g., I frames at port number 5151) according to a first priority level and data associated with a second destination port number (e.g., P and B frames both at port number 5153) according to a lower priority level, such that, when congestion in Third Network 500 requires that data within the router be discarded, the data associated with the second destination port number (e.g., P and B frames at port number 5153) is discarded before data associated with the first destination port number (e.g., I frames at port number 5151). In another example, Router 600 may be configured to route data associated with a first, a second, and a third destination port number (e.g., I frames at port number 5151, P frames at port number 5153, and B frames at port number 5155) according to a first, a second, and a third priority level, respectively, such that, when congestion in Third Network 500 requires that data within the router be discarded, the data associated the third destination port number (e.g., B frames at port number 5155) is discarded before data associated with the first and second destination port numbers (e.g., I frames at port number 5151 and P frames at port number 5153, respectively), and data associated with the second destination port number is discarded before data associated with the first destination port number.

Data of the data stream associated with the first designation and the one or more designations other than the first designation that is not discarded by Router 600 due to congestion in Third Network 500, is routed through Third Network 500 and received at Router 700, which then routes the data of the data stream in a similar manner as described above with respect to Second Network 400. For example, Router 700 routes data of the data stream received by it from Third Network 500 such that data of the data stream associated with the first designation is routed according to a first priority level and data of the data stream associated with the one or more designations other than the first designation is routed according to one or more priority levels lower than the first priority level such that, when congestion in Second Network 400 requires that data within the router be discarded, the data associated with the designations to be routed according to a lower priority level is discarded before data associated with the designations to be routed according to a higher priority level.

Returning to FIG. 4, next, as represented in block 1400, data of the data stream associated with the first designation and the one or more designations other than the first designation that has not been discarded due to congestion (e.g., by Router 600 due to congestion in Third Network 500 or by Router 700 due to congestion in Second Network 400), is received at Client 200. Where the data stream comprises a video stream, the operations represented in block 1400 may be accomplished by, for example, DSR System 210 of Client 200 receiving I frames at a first destination port number (e.g., 5151) and P and B. frames at one or more destination port numbers other than the first destination port number (e.g., P and B frames both at port number 5153 or P and B frames at port numbers 5153 and 5155, respectively).

The data of the data stream that was received separately in association with the first designation and the one or more designations other than the first designation are then combined to provide a representation of the data stream, as represented in block 1500. For example, where the data stream comprises a video stream, the operations represented in block 1500 may comprise DSR 210 of Client 200 combining the I frames received on the first destination port number (e.g., 5151) and related to a given video stream (e.g., data from a given IP address and having a given source port number) with P and B frames received on one or more destination port numbers other than the first port number (e.g., P and B frames both on 5153 or P and B frames on 5153 and 5155, respectively) and related to the same video stream to provide a representation of the given video stream, as previously described.

Finally, the representation of the data stream is processed for presentation to a user, as represented in block 1600. For example, where the representation of the data stream comprises a video stream, DS Processing System 220 of Client 200 may process the representative video stream to present to the user operating Client 200 the video encoded within the representative video stream.

In the embodiment of the invention described above, Server 100 transmits data to Client 200 and Routers 600 and 700 route data according to two or more priority levels with respect to congestion in Third Network 500 and Second Network 400, respectively. In the embodiment of the invention shown in FIG. 2 where End User Systems 151 and 152 function as both servers and clients, then data sent from End User System 151 to End User System 152 is routed by Router 600, as described above, with respect to congestion in Third Network 500, and is routed by Router 700, as described above, with respect to congestion in Second Network 400. Similarly, data sent from End User System 152 to End User System 151 is routed by Router 700 with respect to congestion in Third Network 500 and is routed by Router 600 with respect to congestion in First Network 300.

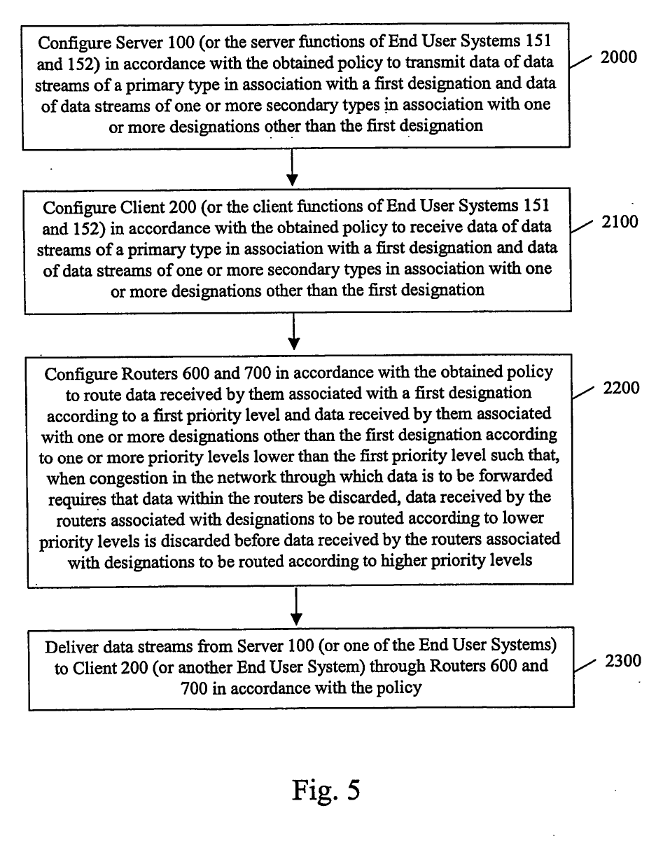

FIG. 5 is a flow chart describing the operation of another embodiment of the invention where Control System 800 configures Server 100, Client 200 (or End User Systems 151 and 152) and Routers 600 and 700 to function in a coordinated manner so that they transmit, receive, and route data, respectively, in association with the same designations and priority levels. First, as represented in block 2000, Server 100 (or the server functions of End User Systems 151 and 152) is configured to transmit data of data streams of a primary type in association with a first designation and data of data streams of one or more secondary types in association with one or more designations other than the first designation. Also, as represented in block 2100, Client 200 (or the client functions of End User Systems 151 and 152) is configured to receive data of data streams of a primary type in association with the first designation and data of data streams of one or more secondary types in association with the one or more designations other than the first designation. In addition, as represented in block 2200, Routers 600 and 700 are configured to route data received by them associated with a first designation according to a first priority level and data received by them associated with one or more designations other than the first designation according to one or more priority levels lower than the first priority level such that, when congestion in the network through which data is to be forwarded requires that data within the routers be discarded, data received by the routers associated with designations to be routed according to lower priority levels is discarded before data received by the routers associated with designations to be routed according to higher priority levels, as described previously.

The operations represented in blocks 2000, 2100, and 2200 maybe accomplished by, for example, Control System 800 obtaining a policy (e.g., by retrieving the policy from a policy server) providing that data of data streams of the primary type and the one or more secondary types be transmitted, received, and routed, as described above. Then Control System 800 may communicate with each of Server 100 and Client 200 (or End User Systems 151 and 152) and Routers 600 and 700 to configure each of them to transmit, receive, and route, respectively, using the designations and corresponding priority levels provided for in the policy.

Next, as represented in block 2300, data streams are delivered from Server 100 (or one of the End User Systems) to Client 200 (or another End User System) through Routers 600 and 700 in accordance with the policy. For example, data streams may be delivered from Server 100 (or one of the End User Systems) to Client 200 (or another End User System) through Routers 600 and.700 in the same manner as described previously in connection with FIG. 4.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for delivering over a network a data stream comprising data of a primary type and one or more secondary types such that processing the data stream requires processing data of the data stream of the one or more secondary types based on the data of the data stream of the primary type, the method comprising:
routing over the network data of the primary type at a first priority level and data of the one or more secondary types at one or more priority levels lower than the first priority level such that, when congestion in the network requires that data be discarded, data of the one or more secondary types is discarded before data of the primary type;
combining data of the primary and the one or more secondary types routed over the network to provide the data stream.

2. The method of claim 1, further comprising transmitting the data stream with data of the primary type being transmitted separately from data of the one or more secondary types; and
wherein the combining comprises combining data of the primary and the one or more secondary types routes over the network to provide the data stream, the provided data stream being at least a representation of the transmitted data stream.

3. The method of claim 2, further comprising:
providing the data stream; and
separating the data of the data stream of the primary type from the data of the data stream of the one or more secondary types prior to the transmitting.

4. The method of claim 1, further comprising processing the provided data stream for presentation to a user.

5. The method of claim 2, wherein the transmitting comprises transmitting the data stream of the primary type in association with a first designation and the data of the data stream of the one or more secondary types in association with one or more designations other than the first designation;
wherein the routing comprises routing data associated with the first designation at the first priority level and data associated with the one or more designations other than the first designation at the one or more priority levels lower than the first priority level such that, when congestion in the network requires that data be discarded, data associated with the one or more designations other than the first designation is discarded before data associated with the first designation; and
wherein the combining comprises combining data associated with the first designation and data associated with the one or more designations other than the first designation routed over the network to provide the data stream that is at least a representation of the transmitted data stream.

6. The method of claim 5, wherein the transmitting comprises transmitting data of the data stream of the one or more secondary types in association with a second designation; and
wherein the combining comprises combining data associated with the first designation and data associated with the second designation routed over the network.

7. The method of claim 5, wherein the transmitting comprises transmitting data of the data stream of one of the secondary types in association with a second designation and transmitting data of the data stream of another of the secondary types in association with a third designation;
wherein the routing comprises routing data associated with a first, a second, and a third designation at a first priority level, a second priority level lower than the first, and a third priority level lower than the second, respectively, such that, when congestion in the network requires that data be discarded, data associated with the third designation is discarded before data associated with the first and second designations, and data associated with the second designation is discarded before data associated with the first designation; and
wherein the combining comprises combining data associated with the first, the second, and the third designations routed over the network to provide the data stream that is at least a representation of the transmitted data stream.

8. The method of claim 2, wherein the transmitted data stream comprises a video stream,
wherein the transmitting comprises transmitting the video stream, wherein the key frames and the predictive frames of the video stream are transmitted separately;
wherein the routing comprises routing over the network key frames at a first priority level and predictive frames at one or more priority levels lower than the first priority level such that, when congestion in the network requires that data be discarded, predictive frames are discarded before key frames; and
wherein the combining comprises combining key frames and predictive frames routed over the network to provide the data stream that is at least a representation of the transmitted video stream.

9. The method of claim 8, wherein the transmitting comprises transmitting key frames of the video stream in association with a first port number and predictive frames of the video stream in association with one or more port numbers other than the first port number;
wherein the routing comprises routing data in association with a first port number at a first priority level and data in association with one or more port numbers other than the first port number at one or more priority levels lower than the first priority level such that, when congestion in the network requires that data to be routed be discarded, data to be routed in association with the one or more port numbers other than the first port number is discarded before data to be routed in association with the first port number; and
wherein the combining comprises combining data routed over the network associated with the first port number with data routed over the network associated with the one or more port numbers other than the first port number to provide the data stream that is at least a representation of the transmitted video stream.

10. The method of claim 9, wherein the first port number includes a first TCP/UDP port number and the one or more port numbers other than the first port number include one or more TCP/UDP port numbers other than the first TCP/UDP port number.

11. The method of claim 2, where data routed over the network is transmitted to a router, and wherein the router routes the data of the primary type in association with the first priority level and the data of the one or more secondary types in association with the one or more priority levels lower than the first priority level.

12. A method for facilitating the delivery of a data stream comprising data of a primary type and one or more secondary types such that processing the data stream requires processing data of the data stream of the one or more secondary types based on the data of the data stream of the primary type, the method comprising:
providing the data stream;
separating the data of the data stream of the primary type from the data of the data stream of the one or more secondary types; and
transmitting data of the data stream of the primary type in association with a first designation and data of the data stream of the one or more secondary types in association with one or more designations other than the first designation.

13. The method of claim 12, wherein the data stream comprises a video stream;
wherein the providing comprises providing the video stream;
wherein the separating comprises separating I frames of the video stream from P and B frames of the video stream; and
wherein the transmitting comprises transmitting the I frames of the video stream in association with a first designation and the P and B frames of the video stream in association with one or more designations other than the first designation.

14. The method of claim 13, wherein the transmitting comprises transmitting the I frames of the video stream in association with a first port number and the P and B frames of the video stream in association with one or more port numbers other than the first port number.

15. A method for presenting a data stream to a user, comprising:
receiving data in association with a first designation and data in association with one or more designations other than the first designation;
combining the data received in association with the first designation with the data received in association with the one or more designations other than the first designation to provide the data stream; and
processing the data stream for presentation to the user by processing the data of the data stream received in association with the one or more designations other than the first designation based on the data of the data stream received in association with the first designation.

16. The method of claim 15, wherein the data stream comprises a video stream;
wherein the receiving comprises receiving I frames in association with a first designation and P and B frames in association with one or more designations other than the first designation;
wherein the combining comprises combining the I frames received in association with the first designation with the P and B frames received in association with the one or more designations other than the first designation to provide the video stream; and
wherein the processing comprises processing the video stream for presentation to the user by processing the P and B frames of the video stream received in association with the one or more designations other than the first designation based on the I frames of the video stream received in association with the first designation.

17. The method of claim 16, wherein the receiving comprises receiving I frames in association with a first port number and P and B frames in association with one or more port numbers other than the first port number;
wherein the combining comprises combining the I frames received in association with the first port number with the P and B frames received in association with the one or more port numbers other than the first port number to provide the video stream; and
wherein the processing comprises processing the video stream for presentation to the user by processing the P and B frames of the video stream received in association with the one or more port numbers other than the first port number based on the I frames of the video stream received in association with the first port number.

18. A system for presenting a data stream to a user, the data stream comprising data of a primary type and one or more secondary types such that processing the data stream requires processing data of the data stream of the one or more secondary types based on the data of the data stream of the primary type, the system comprising:
a first computer for providing the data stream and transmitting the data of the data stream of the primary type in association with a first designation and data of the data stream of the one or more secondary types in association with one or more designations other than the first designation;
a router for receiving the data transmitted by the first computer in association with the first designation and routing this data associated with the first designation through a network in accordance with a first priority level and for receiving the data transmitted by the first computer in association with the one or more designations other than the first designation and routing this data associated with the one or more designations other than the first designation through the network in accordance with one or more priority levels lower than the first priority level such that, when congestion in the network requires that data received at the router be discarded, data received at the router in association with the one or more designations other than the first designation is discarded before data received at the router in association with the first designation;
a second computer for receiving data through the network from the router associated with the first designation and the one or more designations other than the first designation, combining the data received through the network from the router associated with the first designation with the data received through the network from the router associated with the one or more designations other than the first designation to provide a data stream representative of the data stream provided by the first computer, and processing the representative data stream for presentation to the user.

19. The system of claim 18, wherein the data stream comprises a video stream;
wherein the first computer provides the video stream and transmits I frames of the video stream in association with a first designation and P and B frames in association with one or more designations other than the first designation; and
wherein the second computer combines the data received through the network from the router associated with the first designation with the data received through the network from the router associated with the one or more designations other than the first designation to provide a video stream representative of the video stream provided by the first computer, and processes the representative video stream to display the video encoded therein to the user.

20. The system of claim 19, wherein the first computer transmits I frames of the video stream in association with a first port number and P and B frames in association with one or more port numbers other than the first port number;
wherein the router receives the data transmitted by the first computer in association with the first port number and routes this data associated with the first port number through a network in accordance with the first priority level and for receiving the data transmitted by the first computer in association with the one or more port numbers other than the first port number and routes this data associated with the one or more port numbers other than the first port number through the network in accordance with the one or more priority levels lower than the first priority level such that, when congestion in the network requires that data received at the router be discarded, data received at the router in association with the one or more port numbers other than the first port number is discarded before data received at the router in association with the first port number; and
wherein the second computer receives data through the network from the router associated with the first port number and the one or more port numbers other than the first port number, and combines the data received through the network from the router associated with the first port number with the data received through the network from the router associated with the one or more port numbers other than the first port number to provide the video stream representative of the video stream provided by the first computer.

21. A system for facilitating the delivery of a data stream comprising data of a primary type and one or more secondary types such that processing the data stream requires processing data of the data stream of the one or more secondary types based on the data of the data stream of the primary type, the system comprising:
means for providing the data stream;
means for separating the data of the data stream of the primary type from the data of the data stream of the one or more secondary type; and
means for transmitting data of the data stream of the primary type in association with a first designation and data of the data stream of the one or more secondary types in association with one or more designations other than the first designation.

22. The system of claim 21, wherein the data stream comprises a video stream;
wherein the means for providing comprises means for providing the video stream;
wherein the means for separating comprises means for separating the I frames of the video stream from the P and B frames of the video stream; and
wherein the means for transmitting comprises means for transmitting the I frames of the video stream in association with a first designation and the P and B frames of the video stream in association with one or more designations other than the first designation.

23. The system of claim 22, wherein the means for transmitting comprises means for transmitting the I frames of the video stream in association with a first port number and the P and B frames of the video stream in association with one or more port numbers other than the first port number.

24. A system for presenting a data stream to a user, comprising:
means for receiving data in association with a first designation and data in association with one or more designations other than the first designation;
means for combining the data received in association with the first designation with the data received in association with the one or more designations other than the first designation to provide the data stream; and
means for processing the data stream for presentation to the user by processing the data of the data stream received in association with the one or more designations other than the first designation based on the data of the data stream received in association with the first designation.

25. The system of claim 24, wherein the data stream comprises a video stream;
wherein the means for receiving comprises means for receiving I frames in association with a first designation and P and B frames in association with one or more designations other than the first designation;
wherein the means for combining comprises means for combining the I frames received in association with the first designation with the P and B frames received in association with the one or more designations other than the first designation to provide the video stream; and
wherein the means for processing comprises means for processing the video stream for presentation to the user by processing the P and B frames of the video stream received in association with the one or more designations other than the first designation based on the I frames of the video stream received in association with the first designation.

26. The system of claim 25, wherein the means for receiving comprises means for receiving I frames in association with a first port number and P and B frames in association with one or more port numbers other than the first port number;
wherein the means for combining comprises means for combining the I frames received in association with the first port number with the P and B frames received in association with the one or more port numbers other than the first port number to provide the video stream; and
wherein the means for processing comprises means for processing the video stream for presentation to the user by processing the P and B frames of the video stream received in association with the one or more port numbers other than the first port number based on the I frames of the video stream received in association with the first port number.

27. A computer program product comprising a computer usable medium having computer readable code embodied therein, the computer readable code, when executed, causing a computer to implement a method for facilitating the delivery of a data stream comprising data of a primary type and one or more secondary types such that processing the data stream requires processing data of the data stream of the one or more secondary types based on the data of the data stream of the primary type, the method comprising:
providing the data stream;
separating the data of the data stream of the primary type from the data of the data stream of the one or more secondary types; and
transmitting data of the data stream of the primary type in association with a first designation and data of the data stream of the one or more secondary types in association with one or more designations other than the first designation.

28. The computer program product of claim 27, wherein the data stream comprises a video stream;
wherein, in the implemented method, the providing comprises providing the video stream;
wherein, in the implemented method, the separating comprises separating the I frames of the video stream from the P and B frames of the video stream; and
wherein, in the implemented method, the transmitting comprises transmitting the I frames of the video stream in association with a first designation and the P and B frames of the video stream in association with one or more designations other than the first designation.

29. The computer program product of claim 28, wherein, in the implemented method, the transmitting comprises transmitting the I frames of the video stream in association with a first TCP/UDP port number and the P and B frames of the video stream in association with one or more TCP/UDP port numbers other than the first TCP/UDP port number.

30. A computer program product comprising a computer usable medium having computer readable code embodied therein, the computer readable code, when executed, causing a computer to implement a method for presenting a data stream to a user, the method comprising:
receiving data in association with a first designation and data in association with one or more designations other than the first designation;
combining the data received in association with the first designation with the data received in association with the one or more designations other than the first designation to provide the data stream; and
processing the data stream for presentation to the user by processing the data of the data stream received in association with the one or more designations other than the first designation based on the data of the data stream received in association with the first designation.

31. The computer program product of claim 28, wherein the data stream comprises a video stream;
wherein, in the implemented method, the receiving comprises receiving I frames in association with a first designation and P and B frames in association with one or more designations other than the first designation;
wherein, in the implemented method, the combining comprises combining the I frames received in association with the first designation with the P and B frames received in association with the one or more designations other than the first designation to provide the video stream; and
wherein, in the implemented method, the processing comprises processing the video stream for presentation to the user by processing the P and B frames of the video stream received in association with the one or more designations other than the first designation based on the I frames of the video stream received in association with the first designation.

32. The computer program product of claim 31, wherein, in the implemented method, the receiving comprises receiving I frames in association with a first TCP/UDP port number and P and B frames in association with one or more TCP/UDP port numbers other than the first TCP/UDP port number;
wherein, in the implemented method, the combining comprises combining the I frames received in association with the first TCP/UDP port number with the P and B frames received in association with the one or more TCP/UDP port numbers other than the first TCP/UDP port number to provide the video stream; and
wherein, in the implemented method, the processing comprises processing the video stream for presentation to the user by processing the P and B frames of the video stream received in association with the one or more TCP/UDP port numbers other than the first TCP/UDP port number based on the I frames of the video stream received in association with the first TCP/UDP port number.
